(19) United States
(12) Patent Application Publication
(10) Pub. No.: US 2010/0144287 A1
(43) Pub. Date: Jun. 10, 2010

(54) WIRELESS COMMUNICATION DEVICE UTILIZING EXTERNAL PROCESSORS AND MEMORIES

(76) Inventor: Horen Chen, Saratoga, CA (US)

Correspondence Address: NORTH AMERICA INTELLECTUAL PROPERTY CORPORATION, P.O. BOX 506, MERRIFIELD, VA, 22116, US

(21) Appl. No.: 12/511,060

(22) Filed: Jul. 28, 2009

Related U.S. Application Data
(60) Provisional application No. 61/120,043, filed on Dec. 4, 2008.

(51) Int. Cl. H04B 1/44

(52) U.S. Cl. 455/75

(57) ABSTRACT

A wireless communication device coupled to a computer includes an antenna for transmitting a transmitted RF signal and receiving a received RF signal, an RF front-end circuit coupled to the antenna, for amplifying and filtering the transmitted RF signal and the received RF signal, and an interface coupled between the computer and the RF front-end circuit. An operating system and protocol stack programs of the wireless communication device are stored in a memory unit of the computer, and are executed on a processing unit of the computer.

### CROSS REFERENCE TO RELATED APPLICATIONS

This application claims the benefit of U.S. Provisional Application No. 61/120,043, filed on Dec. 4, 2008 and entitled “SIMPLIFIED CELLULAR COMMUNICATION MODULES/MODEMS CONNECTED WITH HOST/EXTERNAL PROCESSORS/MEMORIES”, the contents of which are incorporated herein.

### BACKGROUND OF THE INVENTION

1. Field of the Invention

The present invention relates to a wireless communication device, and more particularly, to a wireless communication device using processors and memories of a host computer coupled to the wireless communication device.

2. Description of the Prior Art

With advancement of wireless communication technologies, a wireless internet function has been a necessity for computers and mobile communication devices. The wireless internet function can be implemented with various standards, such as 3G, IEEE 802.11 a/b/g/n, WiMax, etc. A desktop or notebook computer uses a wireless communication device which is installed in the computer as a module, or is inserted to the computer as a card adapter, or is modem connected to the computer, to connect with the network.

Please refer to FIG. 1, which is a functional block diagram of a communication system 10 according to the prior art. The communication system 10 includes a computer 100 as a host device and a wireless communication device 102 coupled to the computer 100 for executing wireless communication functions, such as internet access, VoIP calls, or mobile phone calls. The computer 100 includes a memory unit 104 and a processing unit 106 including multiple central processing units (CPU) and digital signal processors (DSP). The wireless communication device 102 includes an antenna 110, a radio frequency circuit 130 including RF front-end circuitry and an RF transceiver, a baseband circuit 140 including a CPU 142 and a DSP 144, a power management unit (PMU) 150, a memory unit 160 including a flash memory 162 and a random access memory (RAM) 164, and an interface 170.

As shown in FIG. 1, the wireless communication device 102 has a full but complicated architecture. The size, power consumption, and cost of the wireless communication device 102 are not reduced due to the complicated architecture.

### SUMMARY OF THE INVENTION

The present invention therefore provides a wireless communication device that utilizes external memories and processing units in place of internal memories and processing units of the wireless communication device.

The present invention discloses a wireless communication device, which is coupled to a computer including a memory unit and a processing unit. The wireless communication device includes an antenna for transmitting a transmitted RF signal and receiving a received RF signal, an RF front-end circuit coupled to the antenna, for amplifying and filtering the transmitted RF signal and the received RF signal, and an interface coupled between the computer and the RF front-end circuit. An operating system and protocol stack programs of the wireless communication device are stored in the memory unit of the computer, and are executed on the processing unit of the computer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communication system according to the prior art.

FIG. 2 to FIG. 4 are functional block diagrams of communication systems according to embodiments of the present invention.

### DETAILED DESCRIPTION

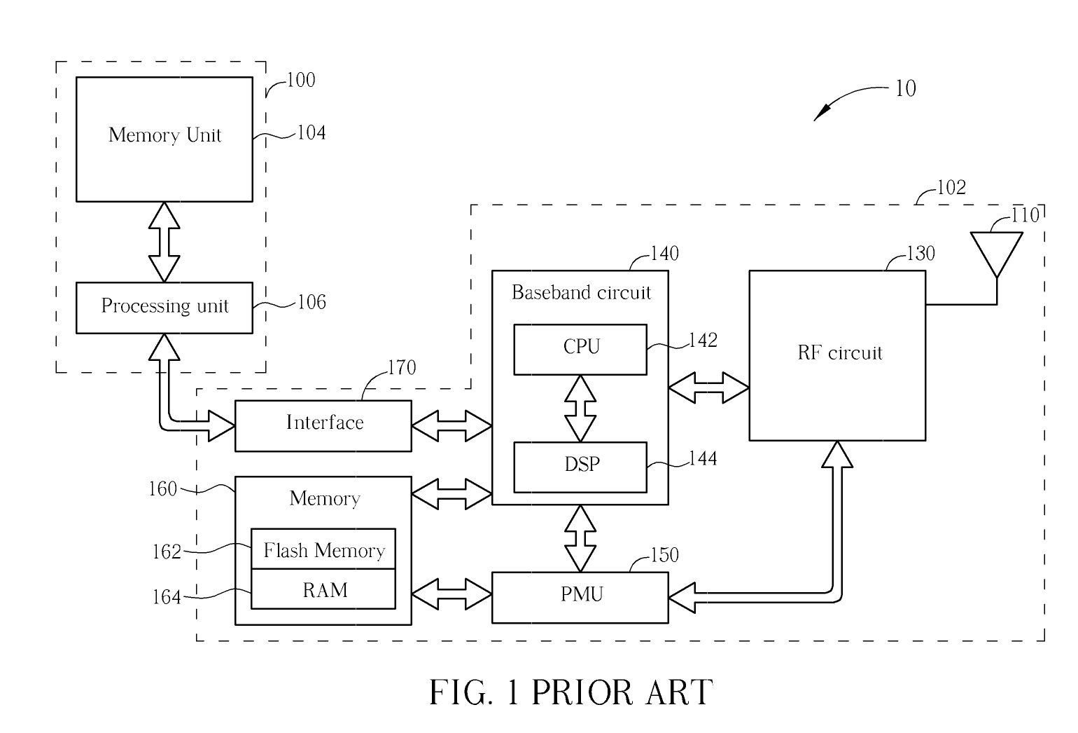

As shown in FIG. 1, some hardware resources have similar functions in the computer 100 and in the wireless communication device 102, such as CPUs, DSPs, and memories. In fact, computing capability of the processing unit 106 is powerful enough to handle tasks of internal CPUs and DSPs of the wireless communication device 102. Besides, size of flash memories and RAMs in the memory unit 104 is much greater than the internal flash memory 162 and the RAM 164 of the wireless communication device 102. Therefore, the inventive concept of the present invention is to move programs and tasks of a wireless communication device to a host computer, so that architecture of the wireless communication device is simplified, and thereby system complexity, size, and cost of the wireless communication device are reduced. The host computer can be a notebook computer, desktop computer, netbook, ultra mobile personal computer (UMPC), mobile internet device (MID), or smartphone application processor system. The wireless communication device can be a module or a modem.

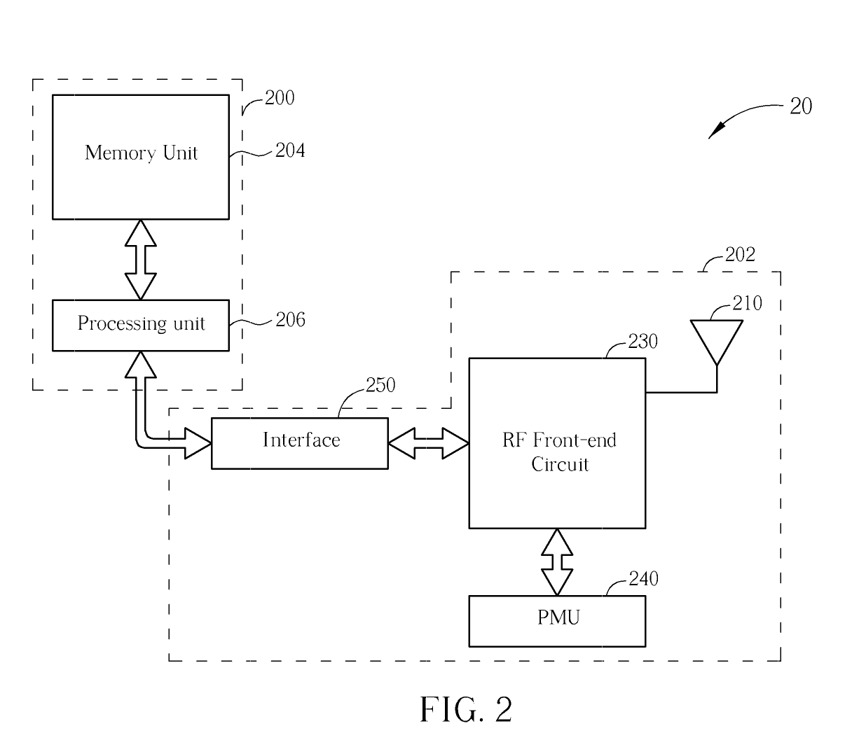

Please refer to FIG. 2, which is a functional block diagram of a communication system 20 according to an embodiment of the present invention. The communication system 20 comprises a computer 200 and a wireless communication device 202 having the most simplified architecture. The computer 200 is a host device and comprises a memory unit 204 and a processing unit 206 including a CPU and a DSP at least. The wireless communication device 202 comprises an antenna 210, an RF front-end circuit 230, a PMU 240, and an interface 250. Compared with the wireless communication device 102 in FIG. 1, an RF transceiver, a baseband circuit, and a memory unit are removed from the wireless communication device 202. Note that, the RF transceiver, the baseband circuit, and the memory unit can be removed or reduced step by step, which is introduced in detail as follows.

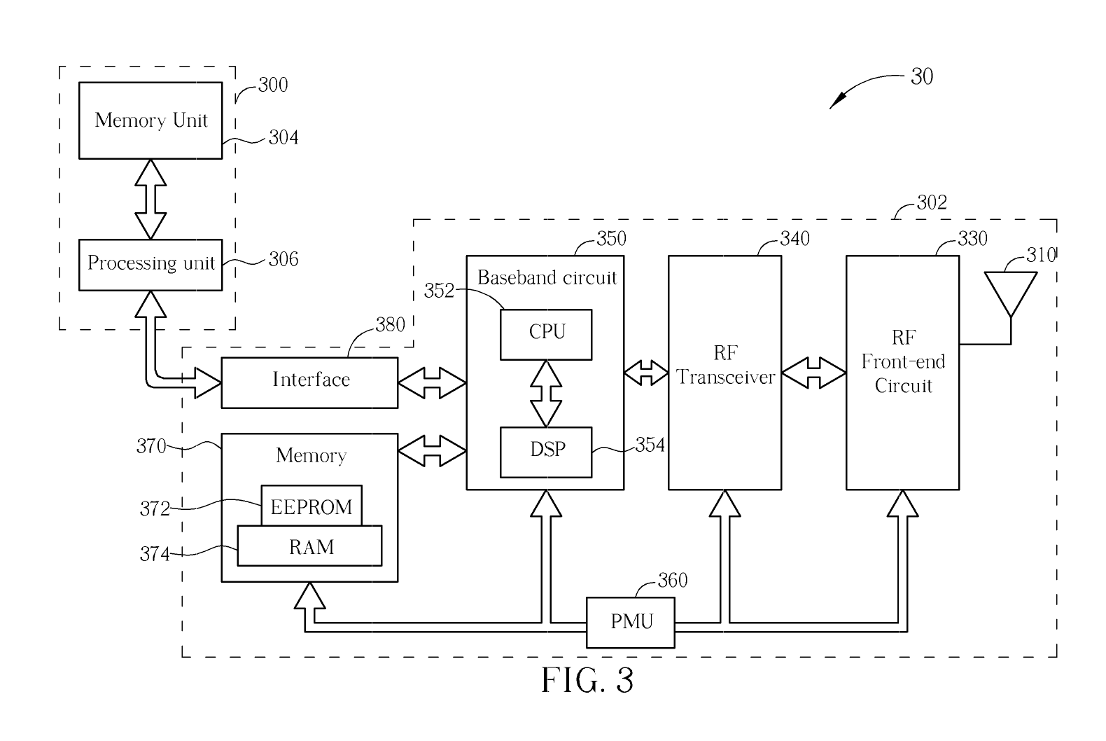

Please refer to FIG. 3, which is a functional block diagram of a communication system 30 according to an embodiment of the present invention. The communication system 30 comprises a computer 300 as a host device and a wireless communication device 302 for executing wireless communication functions. The computer 300 comprises a memory unit 304 and a processing unit 306, which are only parts of the computer 300 related to the wireless communication device 302, and other parts of the computer 300 are omitted herein. The wireless communication device 302 comprises an antenna 310, an RF front-end circuit 330, an RF transceiver 340, a baseband circuit 350 including a CPU 352 and a DSP 354, a PMU 360, a memory unit 370 including an electrically-erasable programmable read-only memory (EEPROM) 372 and a RAM 374, and an interface 380. The antenna 310 is utilized for transmitting and receiving RF signals. The signal transmitting/receiving paths are switched via a switch coupled between the antenna 310 and the RF front-end circuit 330, which is not illustrated in FIG. 3. The RF front-end circuit 330 is coupled to the antenna 310, and is utilized for amplifying and filtering a transmitted RF signal and a received RF signal. The RF transceiver 340 is coupled to the RF front-end circuit 330 and the baseband circuit 350, and is utilized for performing modulation on a transmitted baseband signal outputted from the baseband circuit 350 to generate the transmitted RF signal, and for performing demodulation on the received RF signal to generate a received baseband signal to be processed via the baseband circuit 350.

The CPU 352 is coupled to the RF transceiver 340, and is utilized for executing protocol stack programs of the wireless communication device 302 to process the transmitted baseband signal, which is transmitted from the processing unit 306 of the computer 300, and the received baseband signal, which is transmitted from the RF transceiver 340. The DSP 354 is coupled to the CPU 352, and is utilized for performing digital signal processing on the transmitted baseband signal and the received baseband signal. The interface 380 is coupled between the processing unit 306 and the baseband circuit 350, and is utilized for transmitting the transmitted baseband signal and the received baseband signal. The interface 380 uses one of various computer interface standards, such as Personal Computer Memory Card International Association (PCMCIA), Peripheral Component Interconnect (PCI) Express, Universal Serial Bus (USB), and so on. For example, an audio or video data is transmitted from the computer 300 to the wireless communication device 302, each unit in the wireless communication device 302 operates sequentially, and in the end, the audio data is converted into an RF signal, transmitted via the antenna 310. Note that, the CPU 352 and the DSP 354 are only parts of multiple CPUs and DSPs of the baseband circuit 350. The power management unit 360 is utilized for controlling power to the RF front-end circuit 330, the RF transceiver 340, the baseband circuit 350, and the memory circuit 370, and is also utilized for performing many power functions, e.g., charging batteries and monitoring power connection, which are not introduced herein.

For the reason that flash memories or hard disks in the memory unit 304 is large enough, protocol stack programs and an operation system of the wireless communication device 302 can be stored in the memory unit 304 instead of an internal flash memory of the wireless communication device 302. The wireless communication device 302 uses the cheaper and smaller EEPROM 372 instead for storing a part of the operating system and parameters. The protocol stack programs and the operation system are downloaded to the RAM 374 through a booting process, and are executed on the wireless communication device 302. Compared with the conventional wireless communication device 102, the wireless communication device 302 has a reduced cost by using an EEPROM instead of a flash memory. Note that, the EEPROM 372 can be replaced with another kind of non-volatile memory, and the RAM 374 can be one of various volatile memories, such as synchronous dynamic random access memory (SDRAM).

For the reason that the protocol stack programs and the operating system are not stored in the RAM 374, in another embodiment, the RAM 374 can be greatly reduced, compared with the RAM 164 in FIG. 1. Note that, computing capability of the processing unit 306 is powerful enough to process what the CPU 352 and the DSP 354 do, therefore the CPU 352 can be implemented by software, stored in the memory unit 304, and executed by the processing unit 306. In another embodiment, the CPU 352 is reduced to a lower-level CPU, or is removed. The lower-level CPU is required when executing some real-time critical tasks on the wireless communication device 302. Also, functions of the DSP 354 can be executed by the processing unit 306, and the DSP 354 can be reduced to a lower-level DSP, or be removed. Note that, in another embodiment, both the CPU 352 and the DSP 354 can be lower-level processors, or only one of the CPU 352 and the DSP 354 can be a lower-level processor. The wireless communication device 302 can operate normally in the situation that both the CPU 352 and the DSP 354 are removed, or only one of the CPU 352 and the DSP 354 is removed.

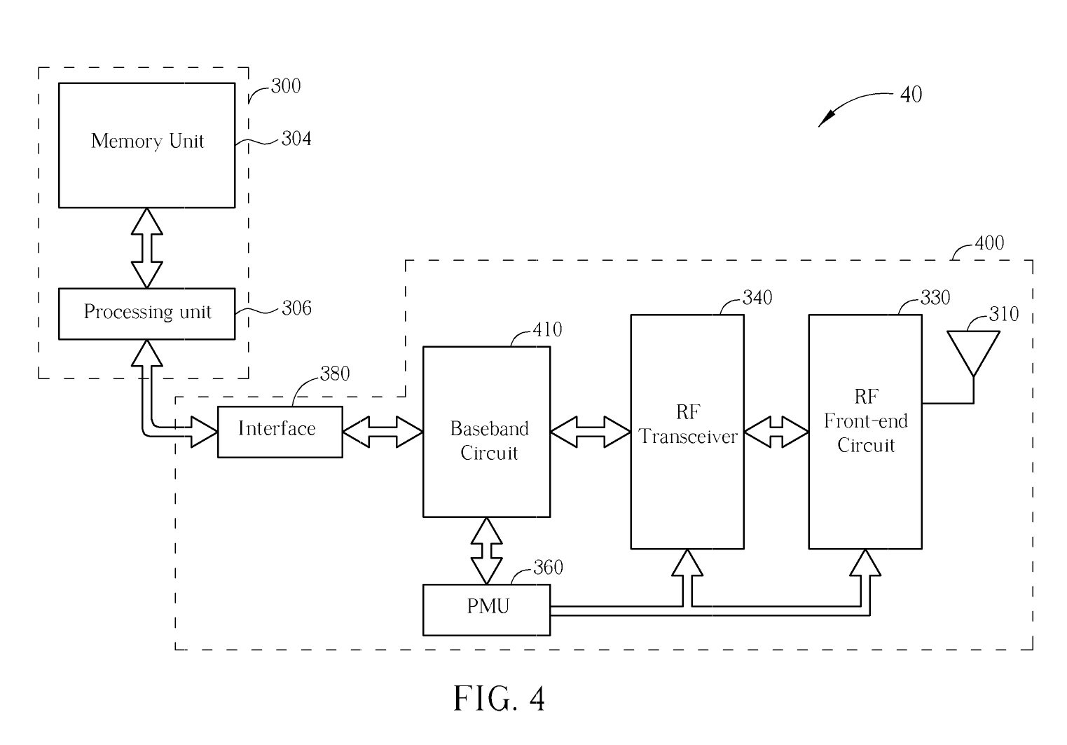

Please refer to FIG. 4, which is a functional block diagram of a communication system 40 according to an embodiment of the present invention. The communication system 40 comprises the computer 300 as in FIG. 3 and a wireless communication device 400. The wireless communication device 400 comprises the antenna 310, the RF front-end circuit 330, the RF transceiver 340, the PMU 360, the interface 380, and a baseband circuit 410 not comprising any CPU and DSP. Operation and coupling relationship of each unit of communication system 40 is similar to the same unit in the communication system 30, which are not repeated herein. The protocol stack programs and the operation system of the wireless communication device 400 are not stored and are not executed on the wireless communication device 400. Therefore, there is no internal CPU, DSP, or memory unit required in the wireless communication device 400. Most of baseband functions are performed by the processing unit 306. As a result, the size, cost, and power consumption of the wireless communication device 400 are greatly reduced.

From the above, the originally existed flash memory, RAM, CPU, and DSP are reduced or removed step by step to optimize a wireless communication device. Furthermore, when an RF transceiver of a wireless communication device is implemented by software stored and executed in a host computer, the hardware RF transceiver can be removed, as shown in FIG. 2, to form the most simplified architecture of the wireless communication device. In FIG. 2, the RF front-end circuit 230 is directly coupled to the interface 250; all the baseband processing tasks and RF modulation/demodulation are moved to the processing unit 206. A transmitted RF signal is directly generated by the processing unit 206, and a received RF signal is directly transmitted to the processing unit 206 to be processed. In another embodiment, the RF front-end circuit 230 can be a reduced front-end circuit when parts of RF front-end circuit 230 are implemented by software executed by the process unit 206. How many functions, features, interface options, and performance of the wireless communication device can be achieved depends on the capacity of the available processing unit and memory unit of the host computer.

In conclusion, the present invention reduces or removes one, more than one, or all the CPUs, DSPs, and memories of the wireless communication device by using the processing unit and the memory unit of the host computer to execute protocol stack programs and digital signal processing functions. Therefore, system complexity, size, power consumption, and cost of the wireless communication device are reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication device, coupled to a computer comprising a first processing unit and a first memory unit, the wireless communication device comprising:
an antenna for transmitting a transmitted radio frequency (RF) signal and receiving a received RF signal;
an RF front-end circuit coupled to the antenna for amplifying and filtering the transmitted RF signal and the received RF signal; and
an interface coupled between the computer and the RF front-end circuit.

2. The wireless communication device of claim 1, wherein an operating system and protocol stack programs of the wireless communication device are executed on the first processing unit of the computer.

3. The wireless communication device of claim 1, wherein an operating system and protocol stack programs of the wireless communication device are stored in the first memory unit of the computer.

4. The wireless communication device of claim 1 further comprising an RF transceiver coupled between the RF front-end circuit and the interface, for performing modulation on a transmitted baseband signal to generate the transmitted RF signal, and for performing demodulation on the received RF signal to generate a received baseband signal.

5. The wireless communication device of claim 1 further comprising a baseband circuit coupled between the RF transceiver and the interface.

6. The wireless communication device of claim 5, wherein the baseband circuit comprises:
a second processing unit for performing protocol stack programs on a transmitted baseband signal and a received baseband signal.

7. The wireless communication device of claim 6, wherein the baseband circuit further comprises:
a digital signal processor coupled to the second processing unit for performing digital signal processing on the transmitted baseband signal and the received baseband signal.

8. The wireless communication device of claim 1 further comprising a second memory unit, the second memory unit comprising a non-volatile memory and a volatile memory.

9. The wireless communication device of claim 8, wherein the first memory unit of the computer and the second memory unit cooperatively store an operating system and programs of the wireless communication device.
